(19) United States
(12) Patent Application Publication
(10) Pub. No.: US 2017/0295012 A1
(43) Pub. Date: Oct. 12, 2017

(54) CRYPTOGRAPHIC SYSTEM BASED ON REPRODUCIBLE RANDOM SEQUENCES

(71) Applicant: Alexandre Andre DURAND, Le Vesinet (FR)

(72) Inventor: Alexandre Andre DURAND, Le Vesinet (FR)

(21) Appl. No.: 15/510,691

(22) PCT Filed: Sep. 14, 2014
(86) PCT No.: PCT/IB2014/064502

§ 371 Date: Mar. 12, 2017

(51) Int. Cl. H04L 9/06; H04L 9/14; H04L 9/30; H04L 9/08

(52) U.S. Cl. CPC H04L 9/0668; H04L 9/0618; H04L 9/0869; H04L 9/14; H04L 9/30

(57) ABSTRACT

In order to have a completely secure cryptographic system, it has been looked for a system unconditionally secure as the One Time Pad, but without its key distribution problem. It is herein disclosed a cryptographic system, which implements a cryptographic process based on a random sequence generating process (1), generating a random key as long as the data to process, for a ciphering process (2) or a deciphering process (3). The random sequences generated by the random sequence generating process (1), being perfectly random, are perfectly reproducible for those who have the correct random-transfer maps (4) and seeds (5). Therefore, we have a very strong cryptographic system without the problem of the key distribution. It even allows to implement an unconditionally secure communication channel over a network. Such cryptographic system can be implemented on very different hardwares, even with limited computing power like smart cards.

### BACKGROUND

### Technical Field

The invention belongs to the field of cryptographic processes and devices. Cryptography is the art to cipher (a.k.a. to encrypt) data or to decipher (a.k.a. to decrypt) enciphered data. Even if this art has long been used by militaries and diplomats, its use has extended nowadays to the public and the business world. It is now economically vital to have a strong and secure cryptographic system to protect business data and bank communications.

### Definitions

Before exposing the prior art, I will give the definition of some technical terms that I will use in this document. These definitions will hold for the whole document (description, claims, abstract).

By the word “data”, I mean all kind of information, knowledge, text, message, document, figures, numerical result, picture, image, combination of some—or of all—of them, or whatever that can be expressed, transcribed or modeled by a sequence of characters.

By “sequence of characters”, I mean a sequence of symbols (letters, numerals, punctuation marks, and so on), of all kind of spaces, of glyphs, of ideograms, of numbers, of several-state-based code (like morse code, teletype code, digital binary code in electronics, and so on), of numerical code (binary, decimal, hexadecimal, or whatever base), possibly following a coding scheme (like ASCII, ANSI, Unicode, Baudot, or others), of any equivalent, or of a combination of some—or of all—of them. And I therefore define “characters” as the elements from which are made the sequences of characters.

By “random sequence”, I mean a sequence of characters where it is impossible to predict which character will be in a particular place in the sequence, even if one knows which are the previous character (and/or the next ones) in the sequence, and this for each place in the sequence. Prior Art

For centuries, The Vigenère Cipher was considered as one of the most secure cryptographic system. It was based on a substitution of each letter by a other one shifted in the order of the alphabet, with a different shift for each letter of the message. In order to remember the sequence of the different shifts, it has been created the system of the “key”. The key is a word, or a sentence, where each letter gives the shift to apply, considering “0” for “A”, “1” for “B”, “2” for “C”, until “25” for “Z”. And the key is looped until the end of the text to cipher.

This technique has been adapted for the “printing telegraph” (teletypewriter) by Gilbert S. Vernam (U.S. Pat. No. 1,310,719) during World War I. In this system, the characters are coded in binary, using the Baudot code. This means that there are only two symbols and two possible shifts: none or “shift to the other symbol”. And since the keys were put on tape, random sequences started to be used, since there was no need to remember the keys anymore.

The first successful attacks made against the Vigenère Cipher was made by Friedrich Kasiski, and more efficient ones was devised by William Friedman. Both techniques were exploiting the fact that the key was used over and over.

In order to fight these techniques, it has been devised to use keys at least as long as the text to cipher. The best way to find such keys was to use a book (unknown to the enemy, of course). However, this kind of cipher was still decipherable, because the key was carrying a meaning.

The solution to that problem was found by major Joseph O. Mauborgne of the US Army. Informed about Vernam's system and its random key, he perfected it by setting the random key as long as the text to cipher and by stipulating that each random key should be used only once.

Such system is known as the One Time Pad, and it has been formally proven that such cryptographic system is completely unbreakable. However, the imposed condition of using a key only once is actually the reason why such full-proof cryptographic system is seldom used: beside the fact that a huge number of random key must be generated, the major problem is to send the keys to the receiver through a secure channel. This is called the “key distribution problem”. It seems obvious that, if such a secure channel would exist, one would use it to directly send his message through it rather than to send a random key and then send an enciphered message.

One attempt to solve this problem is to use a very small random key and to compute from it a pseudo-random sequence (a sequence where all elements are computed from the previous one(s), and/or from previous state(s) of the computation), instead of looping it. This small random key is sent to the receiver, usually using public key cryptography (see below), and the pseudo-random sequence generated from it is used as the ciphering key. This kind of cryptographic systems is called “stream ciphers”.

Just like the One Time Pad, it provides a key as long as the text, with no meaning. However, to the contrary of the One Time Pad, the fact that the elements of the key are related to each other is dramatically weakening the system, eventually allowing a crypt-analyst to break it: in the case of a brute-force attack (where every possible keys are tried in turn), there would be less keys to try (only all the small random keys instead of the full length keys) and the correlation between the computed characters of the key doesn't allow so much spurious keys (if any).

Another family of cryptographic system, also using a “short” random key, is the family of the “block ciphers”. Here, the data are truncated in blocks of fixed length, which are enciphered several times. Each time, called a “turn”, the block is enciphered using several techniques (permutation and substitution), with a different key for each turn, all these keys being computed from the short random key using a defined algorithm. The number of turns is supposed to prevent to crypt-analyze back using traditional techniques. However, compared to the One Time Pad, we have the same problems than stream ciphers against brute-force attacks.

The public key cryptography uses one now-unsolved mathematical problem (like the factorization of huge numbers for instance) in order to encrypt data, instead of a secret key. The basic principle of this family of cryptographic system is to separate the enciphering key and the deciphering key, the enciphering key being public (since it can't be used to decipher the messages) and given to potential senders, the deciphering key being secret and kept by the receiver, and creating a one-way communication channel (therefore, for having a two-way communication channel between two persons, one needs to create two one-way communication channels, which makes two public keys and two secret keys).

So, this scheme solves the “key distribution problem”, since one doesn't need a secure channel to exchange a secret-key-as-long-as-text anymore. However, these cryptographic systems are usually time consuming so, in practice, it is only used to encrypt very short data (like a small truly-random key), long data being encrypted using the previously described cryptographic systems (using the transmitted small random key).

However, it should be known that, to the contrary of the One Time Pad, the public key cryptography is not unconditionally secure, since it is impossible to prove that no-one has (secretly) solved the mathematical problem on which the cryptographic system is based.

### SUMMARY OF THE INVENTION

### Technical problem

Therefore, in order to have a completely secure cryptographic system that is able to resist against the evolution of the technology and the cryptanalytic techniques, a cryptographic system as unconditionally secure than the One Time Pad, but without the “key distribution problem”, is still looked for.

### Disclosure

I am presently disclosing a new cryptographic scheme (with some of its implementations and embodiments) for ciphering (a.k.a. encrypting) data or deciphering (a.k.a. decrypting) enciphered data, using one or several random sequences as keys, such keys being at least as long as the data to process. The disclosed cryptographic process comprises one or several random sequence generating processes, one ciphering and one deciphering processes. Both ciphering and deciphering processes use the random sequence(s) from the random sequence generating processes to cipher and decipher (respectively) data.

In a basic way, one random sequence generating process comprises at least one pseudo-random generating process and one random-mapping process. The pseudo-random generating process sends a pseudo-random sequence to the random-mapping process. The random-mapping process uses the pseudo-random sequence to generate a random sequence, using a random-transfer map for converting the elements of the pseudo-random sequence into random elements for the random sequence. This random-transfer map is actually only provided to people who are allowed to cipher and decipher the data.

In a more complex way, one random sequence generating process may comprises one or several pseudo-random generating processes and several random-mapping processes. One pseudo-random generating process can send its output to one or several random-mapping processes. And one random-mapping process can also receive as input the output of one or several other random-mapping processes, and even a feedback of its own output. Also, the random-transfer map may possibly be transformed for each cryptographic session.

This disclosed cryptographic process can be embodied in several ways, on what is called a “cryptostructure”: computers (desktop, laptop, workstation, or whatever, including tablet computers and mobile phones) with the appropriate software, but also micro-controllers, or embedded electronics, or dedicated electronic circuits, or smart cards, or any of their equivalents, presently existing or developed in the future (this definition of “cryptostructure” will hold for the whole document, including claims).

### Advantages

The cryptographic process being disclosed is using one, or several, random sequences as keys. Until now, such random sequences were generated in a non-reproducible manner, leading to the problem of the key distribution faced by the One Time Pad system. This is due to misconception about randomness, preventing people from making random sequence generator able to reproduce a same (truly) random sequence several times, such as the generator we are disclosing in this document.

For many people, randomness comes from chaotic phenomena that completely escape any rule, leading to completely unpredictable results. Actually, if chaotic phenomena would not follow any rule, it would not be possible to synchronize chaotic systems, but experiments show exactly the opposite.

Moreover, if one throw a die, or draw a color ball from an opaque bag, the result is considered as random. But if the bag is not opaque, or if the die is thrown in exactly the same manner, using the same force and the same amount of energy, the result would no longer been considered as random, because there is a full control of the process, leading to a result that one can desire.

Therefore, we can define randomness as the unpredictability of a result, and this is, actually, the very property of randomness that is used in cryptography. In order to obtain this uncertainty, this result must come from a process on which one don't have the full control. As a consequence, we can deduce that any sequence is random as far as everyone lack some control on the generating process from which the sequence comes from.

Therefore, random sequences can be obtained from a mix of controlled and uncontrolled processes, the uncontrolled processes guaranteeing the randomness of the sequence. In the cryptographic process being disclosed here, a combination of some controlled and uncontrolled processes is used in order to generate random sequences that present the particularity to be reproducible for those (and only those) who have the resulting data from the uncontrolled process. Therefore, such random sequences can be used in order to create a cryptographic system as strong as the One Time Pad, but without the need to distribute a huge amount of keys, since these “one time keys” are actually generated on both sides of the communication channel (in the case of a messaging system, used here as an example).

Here, only the resulting data from the uncontrolled process are needed to be distributed. As a matter of fact, it will be seen in the written description that it is possible to implement an unconditionally secure communication channel, using this cryptographic process. So since we can send these keys through this channel (once established), the “key distribution problem” is solved. We have therefore one of the strongest cryptographic system, with a minimal key distribution matter (but no “key distribution problem”) and that is unconditionally secure, giving one of the most useful cryptographic system available.

### SHORT DESCRIPTION OF THE DRAWINGS

In order to follow more easily the complete description, some drawings are provided with this document. However, it has not been possible to integrate all the cases into one drawing. Therefore, the detailed description will present variations that are not explicitly drawn in the drawing. The drawings are actually an help to visualize the basic principles.

FIG. 1 is a flowchart showing the basic operation of the disclosed cryptographic process.

FIG. 2 is a flowchart showing the internal operation of the random sequence generating process, with optional features. The optional flows are represented with dashed lines.

### DETAILED DESCRIPTION

We will now describe the different embodiments. We will concentrate on the particularities of the disclosed cryptographic process and its embodiments. Therefore, all techniques for improving the strength of cryptographic processes (such as compressing the data in order to minimize redundancies, use of a buffer table sequentially filled and pseudo-randomly picked-in to enhance the sequence randomness, and so on . . . ), known by those who are skilled in the art, will not be mentioned, but their availability for the disclosed cryptographic process and its embodiments is implied.

### Cryptographic Process

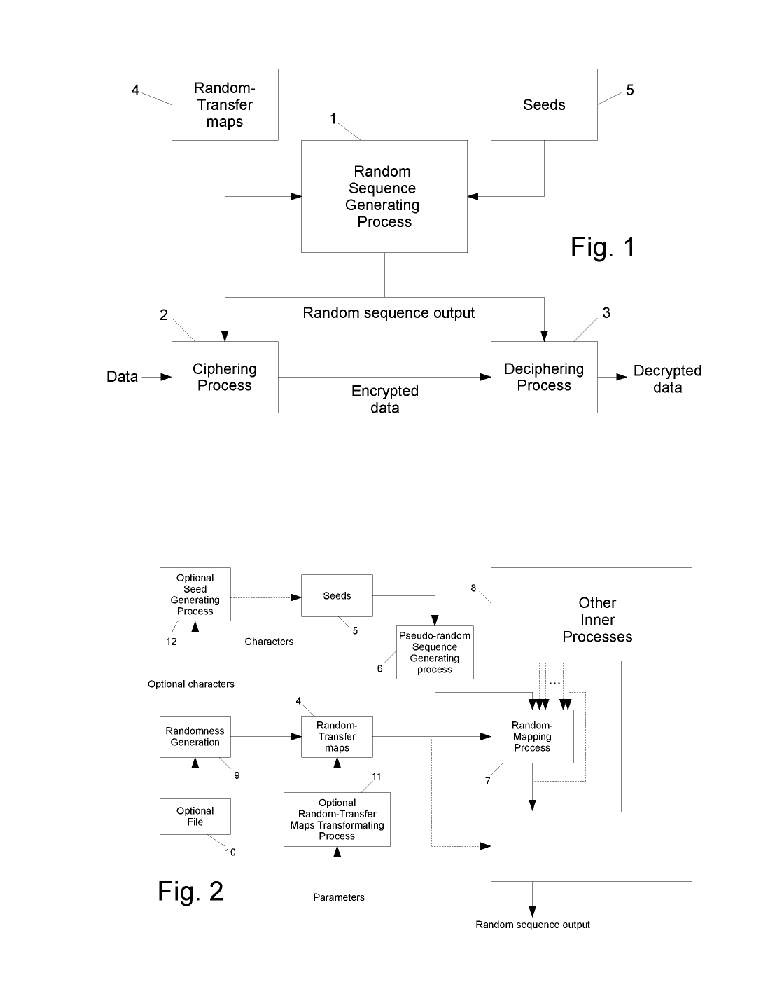

The device embodiments (usually) implement a cryptographic system in order to cipher data, or to decipher enciphered data, following an original cryptographic process herein disclosed. This cryptographic process uses one or several random sequence generating processes 1 (see FIG. 1), a ciphering process 2 and a deciphering process 3. The random sequence generating process 1 is based on one or several pseudo-random sequence generation processes 6 (see FIG. 2), and on one or several random-mapping processes 7.

The pseudo-random sequence generation processes can use a Linear Congruential Generator algorithm (or some of its family), an Inversive Congruential Generator algorithm (or some of its family), a Linear Feedback Shift Register algorithm (or Generalized Feedback Shift Register), a Blum Blum Shub pseudo-random generator algorithm, an algorithm based on one or several chaotic equations (like the logistic difference equation, for example; see U.S. Pat. No. 5,048,086), an algorithm based on one or several chaotic equation systems (like Lorentz system, for example; see U.S. Pat. No. 6,078,665), an algorithm based on fractal equation (like the Julia set, or the Mandelbrot set, for example), or any of these or others pseudo-random generation algorithm whose output is hashed by a hash function, or any pseudo-random generation algorithm desired by the implementor, or any combination of some of them (using a mixing operation—explained later—or whatever operation on the characters from the several outputs).

A “random-mapping process” is a process that uses a random sequence of characters, called a “random-transfer map” 4, in order to map each character from an incoming sequence into a random character for an outgoing sequence, using a map-picking protocol. A “map-picking protocol” is a way to select an element in a sequence from input data, such as modulo-indexing, normalized-indexing, n-dimensional table-indexing, tweaked n-dimensional table-indexing, or any algorithm that uses one or several characters as input in order to determine which character from a sequence (here, the random-transfer map) to pick.

The modulo-indexing protocol consists in using the input character as a number, and this number will indicate the rank in the sequence from which the output character will be picked. If the input character is not a number, one can consider its coding number in some coding scheme (like ASCII, ANSI or Unicode) as the input number. If the input number is larger than the size of the sequence (which is the number of elements of the sequence), the remainder of the euclidian division of the rank number by the size of the sequence is used (hence, the “modulo”, since it's a modular arithmetic operation).

The normalized-indexing protocol is like the modulo-indexing protocol, except that, instead of a modulo operation, the rank is normalized to the size of the sequence. This means that one divide the rank by the highest rank possible and, then, multiply the result by the size of the sequence. The result is rounded up if the rank numbering starts from one, or rounded down if it starts from zero.

In the n-dimensional table-indexing protocol, the sequence is considered as a succession of lines from a table that have n dimensions. This means that the size of the sequence must be the product of the sizes of the table in each dimension. This protocol uses n incoming characters, considered as numbers, as the coordinates of the character to pick in the table.

The tweaked n-dimensional table-indexing protocol is like the n-dimensional table-indexing protocol, except in the way to compute the coordinates of the character to pick. Here, any operation made on the input characters will fit, as far as it will give coordinates within the dimensions of the table. For example, it can be modular arithmetics, logical operations like “exclusive or”, or a pick of selected bits to form numbers (like the S-boxes of DES).

Usually, the embodiments provide several map-picking protocols, letting the user select the protocol to be used. It should be noted, however, that the character indexing method used to pick the character by the map-picking protocol can be different from the one used during the making of the random-transfer map. For instance, one can create a random sequence of ANSI characters, and then, in the map-picking protocol, consider it as a sequence of bits, or vice-versa. Actually, this allows to completely separate the random-map making process from the type of characters required by the output random sequence.

The incoming sequence of a random-mapping process 7 can be a pseudo-random sequence coming from a pseudo-random generation process 6 (it should be noted that a combination of several pseudo-random sequence generation processes, using a “mixing operation”—defined below—of their outputs as an output, is actually considered as one pseudo-random sequence generation process), or a random sequence coming from a previous random-mapping process 8, or a combination (using a “mixing operation” of their characters) of several random sequences coming from several previous random-mapping processes 8, or a combination (using a “mixing operation” of their characters) of some of these possibilities.

By “mixing operation”, I mean an “exclusive or”, a modular addition, a modular subtraction, a concatenation, a Vigenère enciphering, a Beaufort enciphering, a substitution cipher, a modular linear combination, or whatever operation, or sequence of operations, on input characters wanted by the implementor, this computation giving one character or a sequence of several characters as a result. This definition will hold for the whole document (description, claims, abstract).

In some alternate implementations, the incoming sequence comes both from the incoming sequence as described above and from the outgoing sequence of the very random-mapping process 7, as a feedback. In some of these alternate implementations, the feedback is processed in a loop (through the random-mapping process) for a pre-defined number of times before the next character of the other incoming sequence is processed. In others of these alternate implementations, the character of the feedback is combined, using a “mixing operation”, with the character of the other incoming sequence(s). In some of these other alternate implementations, the feedback is delayed by a pre-defined number of characters. In some other implementations, some of, or all, the previously described configurations are provided, including several possible “circuitry”, letting the user select which one will be used. And in some implementations, the user can even design this circuitry.

By “circuitry”, I mean the way the output and the inputs of the inner processes (pseudo-random sequence generating processes and random-mapping processes) of a random sequence generating process are connected each others. The circuitry also specifies which random-mapping process output will be used as the random sequence generating process output.

The random-transfer map 4 is a random sequence of characters, created by “randomness generation” 9, and provided to a random-mapping process 7 in the embodiment. This random-transfer map is the source of randomness (also known as “entropy” by those who are skilled in the art) of our random sequence generator. We have seen that randomness implies two things: unpredictability and lack of control. The unpredictability implies that the random-transfer map must be kept secret and unaccessible to the “enemy” (it is also advised to keep it unaccessible to the users). And the lack of control implies condition that allow us to define the randomness generation.

The “randomness generation” is a process of creation that is not (or not completely) using mathematics or computation, but is using one or several uncontrolled phenomena in order to generate characters. Some of the most obvious embodiments of this process are the hardware “truly”-random generators. Such hardware use, for instance, electronic noise as source of random values, which are post-processed by an algorithm (known as “randomness extraction”). Another example is a more uncommon hardware that measures the time between each disintegration of a radioactive material.

Another family of embodiment uses a text 10 (or a compiled program binary, or whatever file), picked without any rational choice, as the source of randomness. As a matter of fact, in a concealed text, no-one would be able to know which letter would be in a determined place. But usually, the text is post-processed, one or several times, using a “substitutive operation”. The post-process should usually be reproducible, since the embodiment should do it itself. A very well known post-process, even if it's not a substitutive operation, is to divide the data into blocks of bits and to process these blocks using a hash-function (a so-called “one-way-function” that can easily compute a result of a determined size of bits, but whose entry can't be determined from it in a reasonable time).

A substitutive operation is a process that substitute a character by another one, using a specified protocol and, usually, external data. The external data can be characters from another text, or characters typed at random used in a loop, or any other source of data. The specified protocol can be one or several “mixing operations” (as defined above) between the characters of the text and the external data, or a ciphering of the text (with a block cipher, a stream cipher, or whatever) using the external data as key(s), but it can also be a more complex protocol, or a combination of some of them. It is advised that the specified protocol complies to the reproducibility condition given above.

In some embodiments, the random sequence generation process 1 comprises also a random-transfer map transformation process 11. This process transform the provided random-transfer map, that we will call “primary random-transfer map”, into another one, that we will call “secondary random-transfer map”, using provided parameters (randomly typed characters, randomly generated characters, or whatever data) and one or several mixing operations. The secondary random-transfer map will be generated (by applying the mixing operation(s) on each character of the primary random-transfer map with each character of the parameters, looping the parameters until all the primary random-transfer map being processed) and be used by the random-mapping process instead of the primary random-transfer map. Such feature is usually used with different provided parameters for each ciphering session, and usually different parameters for each random-transfer map transformation for one session.

In some alternate embodiments, a random sequence generation process (just like the one 1 disclosed in this document), which can be a dedicated separate one or a part (or the whole) of the one used by the ciphering and/or the deciphering process, is used to transform the primary random-transfer map into the secondary random-transfer map. In this configuration, the provided parameters are used to setup the random sequence generation process, and the generated random sequence is used to transform the primary random-transfer map, using a mixing operation. In some alternate embodiments, the generated random output is directly used as the secondary random-transfer map, instead of transforming the primary random-transfer map.

In some embodiments, the random sequence generation process 1 comprises also a seed generating process 12, which compute seeds 5 (which are starting data needed by a pseudo-random sequence generator in order to start computing the sequence, the values of these data influencing the characters of the sequence) for the pseudo-random generating processes 6. The seed generating process 12 uses a “seed computing algorithm” on provided or picked characters, such picked characters possibly coming from the computer memory or a part of one or several random-transfer maps 4. A “seed computing algorithm” is a algorithm that uses arithmetical, mixing, or whatever operation, or combination of some (or of all) of them, on input characters in order to output some value(s) to be used as seed(s).

At last, the ciphering 2 and deciphering 3 processes can both take place in the same or in separate cryptographic devices. It can use any cryptographic scheme: a Vigenère cipher, a Beaufort cipher, a block cipher, a stream cipher, or whatever cryptographic scheme wanted by the implementor. It can also use any number of keys it needs from the random sequence generating process. As a matter of fact, both ciphering and deciphering process can process the data several times, using several keys (usually different ones).

### Cryptographic Devices

In one family of embodiments, one or several computers, or tablet computers, or mobile phones, standalone or connected to a network, use a software in order to cipher data, or to decipher enciphered data, following the cryptographic process disclosed above, the ciphering 2 and the deciphering 3 processes being both on the same computer (in the following, the word “computer” will also include tablets and mobile phones) or on different computers (both computers having a random sequence generation process). The implementation of the cryptographic process in software is obvious.

In a second family of device embodiments, a dedicated electronic circuit implements the cryptographic process disclosed above. Such circuit comprises several parts, each part implementing one of the steps of the cryptographic process described above (random sequence generators for implementing the processes for generating random sequences 1, a cipherer for implementing the process for ciphering data 2, a decipherer for implementing the process for deciphering enciphered data 3 each of the random sequence generators comprising one or several pseudo-random generator, implementing the pseudo-random sequence generating processes 6, and one or several random-mapper units, implementing the random-mapping processes 7).

Following the disclosed cryptographic process, the pseudo-random generators and the random-mapper units are connected together in a circuitry. This circuitry is usually hardware, but we will see later some embodiments where the circuitry is logically or software-switched. In the hardware case, one or several circuitry can be proposed. They can be switchable, or they can work in parallel.

Each random-mapper unit is using a provided random-transfer map 4 (as defined previously), stored in a storing unit (like a memory or a flash card, for instance) inside the random-mapper unit, this random-transfer map being generated by randomness generation 9 (as defined and described previously).

In an alternative embodiment, each of the random sequence generators also comprises a random-transfer map transformer, which implement the random-transfer map transforming process 11.

In some embodiments, the electronic circuits also embed some micro-controllers, which can implement some programmable multiplexers (between other things), allowing to program the circuitry inside each random sequence generators 1, to select the ciphering circuit (or to implement its computation algorithm) in order to choose the ciphering scheme, the same thing for the deciphering, to select the pseudo-random generators (or to implement its computation algorithm) in order to choose the generation algorithm, and so on.

In some embodiments, the seed generating process 12 is implemented by a seed generator. The implementation is usually hardware, but it can be (partly or completely) software-implemented, in order to be executed by a micro-controller. Also, the randomness generation 9 is implemented in some embodiments, usually in software with a micro-controller, but it can be in hardware.

There are also several other kinds of device embodiments, which implement the cryptographic process described in this document. The amount of features implemented depends on the capacity and the computing power of the structure used for the embodiment.

One kind of embodiments are those where the cryptographic system is implemented on a micro-controller. It is some kind of pocket implementation of the first family of embodiments. The cryptographic process is usually implemented in software on the micro-controller, which is connected on a little electronic circuits, with buttons, jog wheels and other devices for data entry, and some plugs for USB data storage or Internet access (but a Wi-Fi can be embedded). As for the operation, the user uses the devices for data entry to interact with the software on the micro-controller.

Another kind of embodiments is on a smart card. The cryptographic process is implemented in software onboard the chip, which has limited capacities and computing power. The implementor should carefully select which features he will implement on it (depending on what is required by the scope statement). Such embodiments can be used for identification, or for bank transactions or withdrawal, for example. These embodiments are operated just like we use smart cards.

A combination of both previous kinds of embodiments is on some kind of USB key, but instead of flash memory, it has been embedded some electronics, usually with a small chip like smart cards. It's actually an USB plug and play device for computers used for cryptographic purposes. Its operation is obvious.

A special kind of embodiment is the cryptosystem maker, which is a storage unit storing a computer program code that, when loaded in a computer memory, configure this computer to perform the disclosed cryptographic process. Such storage unit is made using what is called a “storing medium”: a hard drive, a USB key, a CD-ROM, a DVD-ROM, a flash card or whatever that can store a computer program code and that a computer system can access in order to load this program code into its memory (this definition of “storing medium” will hold for the whole document, including claims).

### Embodiments Operation

As for the operation of the first family of device embodiments, the setting of the computer (including tablets and mobile phone) is obviously known by those who are skilled in the art: the appropriate software will be provided to the computer and the computer will load it into its memory. Then, this program will configure the computer to make it perform the disclosed cryptographic process.

After the computer setting, the random-transfer maps are provided to the random sequence generation processes. These random-transfer maps should be only provided to the computers of the users who are allowed to access to the data. If the embodiment implements a random-transfer map generating process, the parameters for the processing session are provided to it, and it generates the secondary random-transfer maps from the random-transfer maps; then the random-transfer maps are substituted by their corresponding secondary random transfer maps in the random sequence generation processes. The primary random-transfer maps may be stored somewhere, in order to be able to be used to generate other secondary random-transfer maps (from other session parameters, during other new sessions).

The data on which one wants to operate are provided to the computer. They may already be on a hard drive (or any other drive), or received from a network, but they are loaded into the memory of the computer. The one or several random sequence generation processes (depending on the implementation) generate one or several random sequences of characters (depending of the number of keys required by the enciphering/deciphering process) of the same length than the data to process.

For this task, one or several seeds are provided to the pseudo-random sequence generation processes (depending of the number of seeds that it requires), which outgoing pseudo-random sequences are sent to the random-mapping process(es), which outgoing random sequence(s) follows the implemented “circuit” until a final outgoing random sequence is sent by the random sequence generation process to the enciphering (or deciphering, depending on the task) process.

This process takes the data from the memory, encipher (respectively decipher) them using its implemented algorithm, and send them back to memory. What follows depend on what one want to do of the data (store them on a hard drive, or any other drive, or send them on a network to a distant receiver, whatever).

There are several ways to provide the random-transfer maps to the random sequence generators: it can be physically transferred to the cryptographic devices (computers and so on), with an USB key or a serially numbered CD-ROM for instance (delivered by a trusted person, or distributed, for instance), they can be sent (through a network for instance) using a secure channel encrypted using the disclosed cryptographic process, or they can be generated onboard the cryptographic device. In the case of physically transferred maps, the random-transfer maps are generated somewhere (using an hardware “truly”-random generator for instance), and then brought to the “authorized” users' cryptographic device, (on a drive, a CD-ROM or on an USB key for instance) and transferred to the correct place into the device. For critical applications, this place would better be unaccessible to the users, but only to an accredited administrator.

With such a method, and other settings that we will see later, it becomes possible to implement an encrypted channel (over a network for instance, or any mean of communication), which means a two-way communication where data are encrypted (the term ‘secure channel’ is also used by those skilled in the art). Since such channel is unconditionally secure (against cipher-text-only attacks), it can therefore be used to transfer new random-transfer maps when needed, instead of physical transfers.

In the case where the random-transfer maps are not transferred to the computers, a file is picked and, usually, transformed using an onboard substitutive operation. For a single user who wants to encrypt some of his data, it can be every file possible, on his drives or on Internet; he just have to remember which files and which external data he used in order to be able to decrypt back his data. For a network of several users using and exchanging common data, everyone should have the same data in order to be able to generate the same random-transfer maps. This is usually done by sending to one of, or all, the others the address(es) (Internet URL or filesystem path) of the file(s) to pick, and possibly remaining external data, using public key cryptography, or the unconditionally secure channel described later for instance. Therefore, each of the receivers makes their computer compute their proper random-transfer maps.

The same procedure used for generating random-transfer maps onboard the computer is used for the parameters needed for generating secondary random-transfer maps, if the feature is implemented in the embodiment. In this case, the circuitry, the file or the external data (randomly typed characters, randomly generated characters, or whatever data) are used by the random-transfer map transformation process in order to create a new random-transfer map (the secondary random-transfer map) for each ciphering session, without having to send a whole random-transfer map (using the ways seen above).

The interest of this feature is that the file or the external data have usually a much smaller size than the random-transfer map, and one bunch of external data may be used for the transformation of all the random-transfer maps, which makes shorter communication for changing the random-transfer maps. As a matter of fact, random-transfer maps are usually changed before the pseudo-random sequence generating process loops back, in order to prevent it to generate an already output sequence. Therefore, to change random-transfer maps before each ciphering sessions allows to simplify the management of the pseudo-random sequence generation, since one has only to check that the needed length for the data processing do not exceed the maximum length of the pseudo-random sequence (actually the maximum length of the random sequence if the random-mapping feedback is used).

For providing the seeds required by the pseudo-random sequence generating processes, several ways are possible. For instance, for a single user wanting to encrypt his data, the software can ask him to enter the seeds he wants to use (which he has to correctly remember), or to ask him for a file (text file—compressed or uncompressed—or binary file) where the first characters, last characters, or predefined (by the implementor) characters are used as seeds. But another way is to reserve a little part of one or several random-transfer maps (usually the end of the map), which will not be used by the random-mapping process, whose data will be used as seeds, or to compute the seeds (using the seed generating process with these values). The advantage of this last way is that the user don't have to care about the seed. One can also see that, if the random-transfer map transformation process is implemented, the seeds are changed for each sessions since the reserved part of the random-transfer map is also transformed by the substitutive operation.

In a multiple user configuration, the method of the reserved part in random-transfer map(s) for generating seeds described above can also be implemented. As a matter of fact, the use of this method (for providing seeds to the pseudo-random sequence generating processes), combined with the implementation of the random-transfer map transformation process and with the physical transfer of the random-transfer maps, allows to implement an unconditionally secure communication channel over a network (as written earlier). Since the random-transfer maps are randomly generated (so it can be any of all possible combination of characters) and can be of any size, since the pseudo-random sequence generation algorithm can be one of many and that the seeds are unknown, since the “circuitry” used internally by the random sequence generating process is one of quite many, an “enemy” has no clue of what's happening inside the cryptographic process and, for him, any combination of characters has the same probability to be the ciphering key, just like the One Time Pad.

And to see the parameters for the random-transfer map transformation process will be of no help for him, because of the randomness and the unknown size of the random-transfer maps, of the unknown pseudo-random sequence generation algorithm, of the unknown changing seeds, of the unknown internal circuitry of the random sequence generation processes that has been selected, of the unknown mixing operation(s) used by the random-transfer map transformation process, of the unknown ciphering protocol used, and of some other unknown parameters. Therefore, in our particular case, these parameters for the random-transfer map transformation process can be sent to other users without the need to be enciphered.

And, still in our particular case, these parameters are the only data that are needed to start a communicating session, so the system is unconditionally secure, and all other needed data, like the new random-transfer maps for instance, can be sent through the secure channel. Therefore, the physical transfer is only required for the setting of the system. This transfer can be done, for instance, using a serially numbered CD-ROM containing the random-transfer maps (and possibly the seeds), so the user just has to send the serial number as parameter in order to set up the encrypted channel.

Outside this case of unconditionally secure communication channel, other ways for providing the seeds required by the pseudo-random sequence generating processes can be public key cryptography, or any method desired by the implementor.

For both single user and multiple user configurations, if the random-transfer map transformation process is not available, it is advised that the seeds would be required only once per random-transfer map, the last values being stored in registers in order to be used as seeds for the next time, until the maximal length of the pseudo-random sequences is reached. It would be advised then, before that time, to change the random-transfer maps in order to not repeat the random sequence.

For critical applications, there is an interesting configuration: the cryptographic devices are connected (possibly wirelessly) in a “star network”, with a network server at the center and the other devices only connected to it (at least). Each device has only the data (random-transfer maps, and so on) to communicate with the server, while the server has the data to communicate with all the devices. If one device want to communicate with an other one on a secure channel, it ciphers the message and send it to the server, the server decipher it, re-encipher it with the data for the other device and send the message to the other device, which can decipher it. The advantage of such configuration is that, if a device (except the server) is captured by an enemy, he can not decipher the other communications with the captured device's data.

As for the operation of the second family of device embodiments, it is working exactly as for the first family of embodiments. Usually, dedicated electronic circuits are just a part of a bigger electronic machine. Sometimes, it's an electronic part connected to a computer, in order to do specialized computations instead of the CPU. So, usually, this family of embodiments comprises “slave” circuits to be controlled by a “Master” circuit.

### The Matter of the Best Mode

Considering that the disclosed cryptographic process can be implemented in several manners, reflecting that different applications asks for different needs, it is difficult to estimate a best mode since opposite needs lead to opposite criteria.

I thus claim:

1. A cryptographic process (for ciphering or deciphering data), comprising:
(a) One or several processes for generating a random sequence, said random sequence being generable in a reproducible manner only by selected people having the adequate data for it,
(b) A process for ciphering (a.k.a. crypting) data, where said processes for generating a random sequence provide one or several keys to said ciphering process, in order to cipher said data,
(c) A process for deciphering (a.k.a. uncrypting) enciphered (a.k.a. crypted) data, said enciphered data being ciphered using said process for ciphering data, where said processes for generating a random sequence provide one or several keys to said deciphering process, said keys being the ones used by said process for ciphering data to encipher said enciphered data, in order to decipher said enciphered data;
each of said processes for generating a random sequence comprising:
(a) one or several pseudo-random sequence generating processes,
(b) one or several random-mapping processes;
each of said random-mapping processes mapping the characters from an incoming sequence into random characters for an outgoing sequence, said incoming sequence being:
(a) the pseudo-random sequence generated by said pseudo-random sequence generating process,
(b) or said outgoing sequence of a previous said random-mapping process,
(c) or a combination by mixing operation of several said outgoing sequences from several previous said random-mapping processes,
(d) or a combination by mixing operation of some of these said incoming sequences,
(e) or both one of these said incoming sequences and a feedback random sequence, said feedback random sequence being said outgoing sequence of said random-mapping process, said feedback random sequence being alternated, or combined by mixing operation, with the other said incoming sequence;
each of said random-mapping processes using a random-transfer map, with a map-picking protocol, in order to map each character of said incoming sequence into a random character to make said random sequence, said random-transfer maps being generated by randomness generation and provided to said random-mapping processes, said random-transfer maps being provided only to said selected people.

2. The process of claim 1, where each of said processes for generating a random sequence is also comprising a random-transfer map transformation process, said random-transfer map transformation process using a primary random-transfer map, and some session parameters provided to said random-transfer map transformation process, in order to generate a secondary random-transfer map, said primary random-transfer map corresponding to said random-transfer map in claim 1, and said secondary random-transfer map being used by said random-mapping process instead of said primary random-transfer map.

3. The process of claim 2, where each of said processes for generating a random sequence is also comprising a seed generating process, said seed generating process computing seeds for said pseudo-random sequence generating processes from provided or picked characters, using a seed computing algorithm.

4. The process of claim 3, where said picked characters are peaked in a part of one or several said random-transfer maps.

5. A cryptographic system comprising means for executing the cryptographic process of claim 1, said means being a cryptostructure.

6. A cryptographic system comprising means for executing the cryptographic process of claim 2, said means being a cryptostructure.

7. A cryptographic system comprising means for executing the cryptographic process of claim 3, said means being a cryptostructure.

8. A cryptographic system comprising means for executing the cryptographic process of claim 4, said means being a cryptostructure.

9. A method of using a cryptographic process, or a cryptographic system, based on the cryptographic process of claim 1, said method comprising the steps:
(a) in a first time, transfer physically said random-transfer maps to said random-mapping processes (or to means for executing said random-mapping processes) of the cryptographic process (or system), said process (or system) possibly also comprising processes (or means) for executing optional processes;
(b) in next times, transfer said random-transfer maps to said random-mapping processes (or to means for executing said random-mapping processes) through a secure channel created using said cryptographic system.

10. A cryptosystem maker product, comprising a storage unit storing a computer program code which, when loaded in a computer memory, configure said computer to perform a cryptographic process based on the cryptographic process of claim 1, said cryptographic process possibly also comprising optional processes, said storage unit being made using a storing medium.
